(19) United States
(12) Patent Application Publication
(10) Pub. No.: US 2025/0085428 A1
(43) Pub. Date: Mar. 13, 2025

(54) Method for Operating a Gated Camera, Control Device for Carrying Out Such a Method, Gated Camera Device Having Such a Control Device and Motor Vehicle Having Such a Gated Camera Device

(71) Applicant: Daimler Truck AG, Leinfelden-Echterdingen (DE)

(72) Inventor: Fridtjof STEIN, Ostfildern (DE)

(21) Appl. No.: 18/290,597

(22) PCT Filed: Jul. 15, 2022
(86) PCT No.: PCT/EP2022/069909

§ 371 Date: Jan. 19, 2024

(30) Foreign Application Priority Data
Jul. 20, 2021 (DE) 10 2021 003 728.6

(51) Int. Cl. G01S 17/931; G01S 7/481; G01S 17/18; G01S 17/89; G06V 20/58

(52) U.S. Cl. CPC G01S 17/931; G01S 7/4815; G01S 17/18; G01S 17/89; G06V 20/58

(57) ABSTRACT

A method for operating a gated camera having a first and second lighting device and an optical sensor. A control of the first and second lighting device and optical sensor are temporally coordinated. The method further includes assigning a visible spacing region to the coordinated control, recording a first recording with the optical sensor by the coordinated control in an event of illumination by the first lighting device, recording a second recording with the optical sensor by the coordinated control in an event of illumination by the second lighting device, recording a third recording with the optical sensor without illumination by one of the lighting devices, forming a first difference recording as a difference between the first recording and the second recording, and forming a second difference recording as a difference between the first recording and the third recording or a difference between the second recording and the third recording.

### BACKGROUND AND SUMMARY OF THE INVENTION

The invention relates to a method for operating a gated camera, to a control device for carrying out such a method, to a gated camera device having such a control device and to a motor vehicle having such a gated camera device.

Methods for operating a gated camera are known, in which an object is recognized due to a shadow cast by an object. These methods are based on the assumption that a measure for a reflective power in particular of diffusely reflecting surfaces, and thus in particular surfaces which are not self-luminous, in particular an albedo, of the object and of an environment of the object is great enough, such that enough photons are reflected in the direction of the gated camera to be able to record a high-contrast recording. In particular, a more high-contrast recording can be recorded by means of the gated camera the greater the albedo is. In addition, it is in particular known that the shadow cast by the object can be detected more reliably if the albedo is large, and thus enough photons are reflected, in particular diffusely, from the object and the environment of the object for the exposure of the optical sensor. A disadvantage of these methods is that the albedo of the environment of the object—in particular of a road surface—can become very low, in particular depending on the surface condition and/or surface coverage. In particular, water puddles on a road surface and/or a very dark road surface cause the albedo to become very low, and no shadows can be detected, and it is thus impossible to recognize an object.

The object of the invention is thus to provide a method for operating a gated camera, a control device for carrying out such a method, a gated camera device having such a control device and a motor vehicle having such a gated camera device, wherein the specified disadvantages are at least partially alleviated, preferably avoided.

The object is in particular solved by providing a method for operating a gated camera, having a first lighting device, a second lighting device which is spaced apart from the first lighting device, and an optical sensor, wherein a control of the first lighting device, of the second lighting device and of the optical sensor are temporally coordinated with each other, and wherein a visible spacing region is assigned to the coordinated control. A first recording is recorded with the optical sensor by means of the coordinated control in the event of illumination by means of the first lighting device. A second recording is recorded with the optical sensor by means of the coordinated control in the event of illumination by means of the second lighting device. A third recording is recorded with the optical sensor without illumination by means of one of the lighting devices. Subsequently, a first difference recording is formed as a difference between the first recording and the second recording. In addition, a second difference recording is formed as a difference between the first recording and the third recording. As an alternative, the second difference recording is formed as a difference between the second recording and the third recording.

In particular, the third recording corresponds to an ambient light recording, in particular a daylight recording. Advantageously, the influence of ambient light, in particular of daylight, is calculated from the first recording or the second recording by subtracting the third recording. Regions of the visible spacing region can advantageously be identified, in which the albedo is low, in particular close to zero, and thus photons of the first lighting device and/or of the second lighting device are almost exclusively absorbed and/or reflected such that too low a proportion of the emitted photons reach the gated camera for the exposure of the optical sensor.

In the context of the present technical teaching, a reflection of a surface describes how photons which hit this surface are reflected back from the surface. It is possible to differentiate between mirroring reflection—in particular also described as directed reflection—and diffuse reflection. If a plurality of photons are observed, wherein the plurality of photons have an almost identical propagation direction, the plurality of photons are respectively reflected back in a reflection direction in the event of a reflection on the surface. The plurality of reflection directions are almost identical in the case of mirroring reflection, wherein the respective reflection directions depend on the propagation direction. In contrast, the plurality of reflection directions vary significantly in the case of diffuse reflection, wherein a main reflection direction, in particular regardless of the propagation direction, preferably forms perpendicular to the surface (Lambert's law).

The method for generating recordings by means of a temporally coordinated control of at least one lighting device—in particular of the first lighting device and/or the second lighting device—and of an optical sensor is in particular a method known as a gated imaging method; in particular, the optical sensor is a camera which is only sensitively triggered in a particular, limited period of time, which is described as “gated control”, and the camera is thus a gated camera. The lighting device too—in particular the first lighting device and/or the second lighting device—is correspondingly only controlled temporally in a particular, selected period of time, in order to light up a scene on the object, in particular the visible spacing region.

In particular, a pre-determined number of light pulses are emitted by the first lighting device and the second lighting device, preferably respectively having a duration between 5 ns and 20 ns. The beginning and the end of the exposure of the optical sensor is coupled with the number and duration of the emitted light pulses and a start of the lighting. As a result, a particular visible spacing region can be recorded by the optical sensor by the temporal control of the first lighting device and/or the second lighting device, on the one hand, and of the optical sensor, on the other hand, with a correspondingly defined spatial position, i.e., in particular at particular spacings of the near and of the far limit of the visible spacing region of the optical sensor. A spatial position of the optical sensor and of the at least one lighting device—in particular of the first lighting device and the second lighting device—is known from the structure of the gated camera. Preferably, a spatial spacing between the at least one lighting device—in particular the first lighting device and the second lighting device—and the optical sensor is additionally known, and is small in comparison with the spacing of the at least one lighting device—in particular the first lighting device and the second lighting device—or of the optical sensor from the visible spacing region. In the context of the present technical teaching, a spacing between the optical sensor and the visible spacing region is thus the same as a spacing between the gated camera and the visible spacing region.

The visible spacing region is thus that region on the object in three-dimensional space which is depicted in a two-dimensional recording in an image plane of the optical sensor as a result of the number and the duration of the light pulses of the at least one lighting device—in particular the first lighting device and/or the second lighting device—and the start of the lighting in connection with the start and the end of the exposure of the optical sensor by means of the optical sensor.

By contrast, the observation region is in particular the region on the object in three-dimensional space which can be depicted as a whole in a two-dimensional recording—in particular to a maximum—by means of the optical sensor in the case of sufficient lighting and exposure of the optical sensor. In particular, the observation region corresponds to the entire exposable image region of the optical sensor which could theoretically be illuminated. The visible spacing region is thus a sub-set of the observation region in actual space. Correspondingly, only a sub-set of the image plane of the optical sensor is exposed in the method suggested here, wherein this partial region of the image plane is in particular given between a start image line and an end image line.

When the term “on the object” is used here and in the following, a region in actual space is meant. When the term “in the image” is used here and in the following, a region in the image plane of the optical sensor is meant. The observation region and the visible spacing region are given on the object. They correspond to regions in the image in the image plane that are assigned by the laws of imaging and by the temporal control of the at least one lighting device—in particular the first lighting device and/or the second lighting device—and of the optical sensor.

Depending on the start and the end of the exposure of the optical sensor, light pulse photons hit the optical sensor after the lighting by the at least one lighting device—in particular the first lighting device and/or the second lighting device—begins. The further away the visible spacing region is from the at least one lighting device—in particular the first lighting device and/or the second lighting device—and the optical sensor, the longer the temporal duration until a photon which is reflected in this spacing region hits the optical sensor. The temporal spacing between an end of the lighting and a beginning of the exposure increases the further the visible spacing region is from the at least one lighting device—in particular the first lighting device and/or the second lighting device—and from the optical sensor.

According to one embodiment of the method, it is thus in particular possible to define the position and the spatial width of the visible spacing region, in particular a spacing between the near limit and the far limit of the visible spacing region, by a correspondingly suitable choice of the temporal control of the first lighting device and/or the second lighting device, on the one hand, and of the optical sensor, on the other hand.

In a preferred embodiment of the method, the visible spacing region is pre-determined, wherein the temporal coordination of the first lighting device and/or the second lighting device, on the one hand, and of the optical sensor, on the other hand, is correspondingly pre-determined.

In a further preferred embodiment of the method, the temporal coordination of the first lighting device and/or the second lighting device, on the one hand, and of the optical sensor, on the other hand, is pre-determined, wherein the visible spacing region is correspondingly pre-determined from the temporal coordination.

In a preferred embodiment, the first lighting device and/or the second lighting device has at least one surface emitter, in particular a so-called VCSE laser. As an alternative or in addition, the optical sensor is preferably a camera.

In one embodiment of the method, the third recording is recorded after the first recording and after the second recording.

In one embodiment of the method, the third recording is recorded after the first recording. The second recording is recorded after the third recording.

In one embodiment of the method, the third recording is recorded before the first recording and before the second recording.

The method can advantageously be carried out continuously. In one embodiment of the method, when it is continuously carried out, the first recording, the second recording and the third recording are recorded equally frequently per unit of time.

In a preferred embodiment of the method, the first recording, the second recording and the third recording are respectively recorded in a temporal interval of less than 0.1 seconds, preferably less than 0.01 seconds.

In a preferred embodiment, the recordings—in particular the first recording, the second recording and the third recording—are recorded at a recording rate of at least 20 Hz to a maximum of 90 Hz. At a recording rate of at least 20 Hz to a maximum of 90 Hz, it is advantageously unnecessary to consider the vehicle's own speed and/or the speed of the found object to determine a further coordinated control.

According to a development of the invention, it is provided that a method for image registration is applied to the first recording, the second recording and the third recording before the first difference recording and the second difference recording are formed. Advantageously, an own movement of a motor vehicle having the gated camera is compensated for by means of the image registration.

In a preferred embodiment of the method, a method for image registration is applied to the first recording and the second recording, wherein the second recording is adjusted to the first recording or the first recording is adjusted to the second recording to form the first difference recording. In addition, a method for image registration is applied to the second recording and the third recording, wherein the third recording is adjusted to the second recording or the second recording is adjusted to the third recording to form the second difference recording.

In a further preferred embodiment of the method, a method for image registration is applied to the first recording and the second recording, wherein the second recording is adjusted to the first recording or the first recording is adjusted to the second recording to form the first difference recording. In addition, a method for image registration is applied to the first recording and the third recording, wherein the third recording is adjusted to the second recording or the first recording is adjusted to the third recording to form the second difference recording.

According to a development of the invention, it is provided that objects are searched for in the first difference recording and/or the second difference recording.

If an object is arranged in the visible spacing region, and if a shadow cast by the object in the image is visible in at least one recording, selected from the first recording and the second recording, only the shadow cast by the object in the image—but not the object itself—is advantageously depicted in the first difference recording, because the first recording and the second recording differ only in the shadow cast. The object can thus be detected in the first difference recording using the shadow cast in the image.

If the object is arranged in the visible spacing region, and if a shadow cast by the object in the image cannot be seen either in the first recording or in the second recording, it is not easily possible to detect the object in the first difference recording. In particular, a shadow cast by the object in the image can be detected if the environment of the object reflects the photons almost substantially away from the optical sensor in the manner of a mirror—in particular does not reflect them diffusely. In an environment of the object which reflects almost substantially in the manner of a mirror, the environment of the object is depicted at least almost identically in the first recording and/or the second recording as in the third recording. The object—in particular a bright object—can thus advantageously be detected in the second difference recording.

According to a development of the invention, it is provided that blind spots are searched for in the second difference recording, wherein reliability regions of the recordings are defined using the found pixel. In particular, all the pixels of the second difference recording which are not blind spots form the reliability regions of the recordings.

In the context of the present technical teaching, an pixel of a recording is defined as a blind spot if a luminance of the pixel is lower than a pre-determined threshold luminance. In a preferred embodiment, a grey value of the pixels is used as a luminance of the pixels.

In the context of the present technical teaching, the luminance is a measure for the brightness of a pixel.

Preferably, the pre-determined threshold luminance is lower than 0.2, preferably lower than 0.1, preferably lower than 0.05, particularly preferably lower than 0.01.

Advantageously, an pixel characterizes a region of the visible spacing region in the image, which is depicted almost identically, preferably identically, in the first recording and the third recording or in the second recording and the third recording. Furthermore, a reliability region advantageously characterizes a region of the visible spacing region in the image, which is depicted almost identically, preferably identically, in the first recording and the third recording or in the second recording and the third recording.

According to a development of the invention, it is provided that the objects found in the first difference recording are verified using the reliability regions. A robust and reliable object recognition can thus advantageously be implemented.

It can advantageously be assumed that an error-free object recognition cannot be guaranteed in the blind spots, in particular using at least one shadow of the object to be recognized cast in the image in the first difference recording. As an alternative or in addition, it can preferably be assumed that a reliable object recognition can be implemented in the reliability regions, in particular using at least one shadow of the object to be recognized cast in the image in the first difference recording.

Preferably, an object which is recognized in a reliability region is verified. As an alternative or in addition, an object which is recognized in a blind spot is preferably not verified, and the method is preferably started again, wherein a further first recording, a further second recording and a further third recording are recorded.

According to a development of the invention, it is provided that a future movement trajectory of a motor vehicle having the gated camera is determined, i.e., in particular specified, on the basis of the first difference recording and/or the second difference recording. Preferably, the future movement trajectory is additionally determined using the found, and in particular verified objects. Advantageously, it is thus possible to determine the future movement trajectory such that found, and in particular verified objects are not driven over.

In the context of the present technical teaching, the future movement trajectory of the motor vehicle is implemented by means of an actuator system of the motor vehicle, in particular by means of steering movements, acceleration processes and/or braking processes.

According to a development of the invention, it is provided that in the second difference recording, a base point is determined on an object found in the second difference recording. Preferably, an object spacing of the object from the optical sensor and/or from at least one lighting device, selected from the first lighting device and the second lighting device, can be determined using a base point in the image.

If, due to mirroring reflection, the albedo of the environment of the object is low, the object in the image in the second difference recording in particular has a depiction of the object and a depiction of a mirroring of the object, wherein it is preferably assumed that a horizontal symmetry applies in the second difference recording. The base point in the image is thus preferably estimated, in particular determined, as a horizontal line in the image between a maximum extension in the image in the vertical direction and a minimum extension in the image in the vertical direction of the object in the image.

The object is also solved by providing a control device which is equipped to carry out a method according to the invention or a method according to one or more of the previously described embodiments. The control device is preferably designed as a computer device, particularly preferably as a computer, or as a control unit, in particular as a control unit of a motor vehicle. In particular, the advantages which have already been explained in connection with the method result in connection with the control device.

The control device is preferably equipped to be operatively connected to the gated camera, in particular to the first lighting device, the second lighting device and the optical sensor, and is equipped for their respective control.

The object is also solved by providing a gated camera device, which has a gated camera comprising a first lighting device, a second lighting device and an optical sensor, and which has a control device according to the invention or a control device according to one or more of the previously described embodiments, wherein the first lighting device and the second lighting device are arranged spaced apart from each other. In particular, the advantages which have already been explained in connection with the method and the control device result in connection with the gated camera device.

In a preferred embodiment, the first lighting device and the second lighting device are arranged horizontally offset from each other. As an alternative or in addition, the first lighting device and the second lighting device are preferably arranged vertically offset from each other.

In particular, a spacing between the first lighting device and the second lighting device is more than 10 cm, preferably more than 20 cm, preferably more than 50 cm, preferably more than 100 cm, particularly preferably more than 150 cm. In particular, the spacing in a horizontal direction is measured if the first lighting device and the second lighting device are arranged horizontally offset from each other. As an alternative, the spacing in a vertical direction is measured if the first lighting device and the second lighting device are arranged vertically offset from each other. As an alternative, the spacing in particular in an oblique direction is measured if the first lighting device and the second lighting device are arranged horizontally and vertically offset from each other.

The control device is preferably operatively connected to the gated camera, in particular to the first lighting device, the second lighting device and the optical sensor, and is equipped for their respective control.

The object is also solved by providing a motor vehicle having a gated camera device according to the invention or gated camera device according to one or more of the previously described embodiments. In particular, the advantages which have already been explained in connection with the method, the control device and the gated camera device result in connection with the motor vehicle.

In a preferred embodiment, the motor vehicle is designed as an autonomous motor vehicle. As an alternative or in addition, the motor vehicle is preferably designed as a heavy goods vehicle. It is also possible, however, that the motor vehicle is designed as a passenger car, a commercial vehicle or another motor vehicle.

In a particularly preferred embodiment, the motor vehicle is designed in particular as an autonomous heavy goods vehicle. The optical sensor is additionally preferably arranged above the windscreen. As an alternative or in addition, the first lighting device and the second lighting are preferably arranged in the region of the bumper, and have a spacing from each other in the horizontal direction of more than 10 cm, preferably more than 20 cm, preferably more than 50 cm, preferably more than 100 cm, particularly preferably more than 150 cm.

The invention is explained in more detail in the following with reference to the drawings.

### BRIEF DESCRIPTION OF THE DRAWINGS

FIG. 1 shows a schematic depiction of an exemplary embodiment of a motor vehicle;

FIG. 2 shows a flow diagram of an exemplary embodiment of a method for operating a gated camera;

FIG. 3 shows a schematic depiction of a first example of a first recording, a second recording, a third recording, a first difference recording and a second difference recording;

FIG. 4 shows a schematic depiction of a second example of the first recording, the second recording, the third recording, the first difference recording and the second difference recording; and

FIG. 5 shows a schematic depiction of the second example of the second difference recording.

### DETAILED DESCRIPTION OF THE DRAWINGS

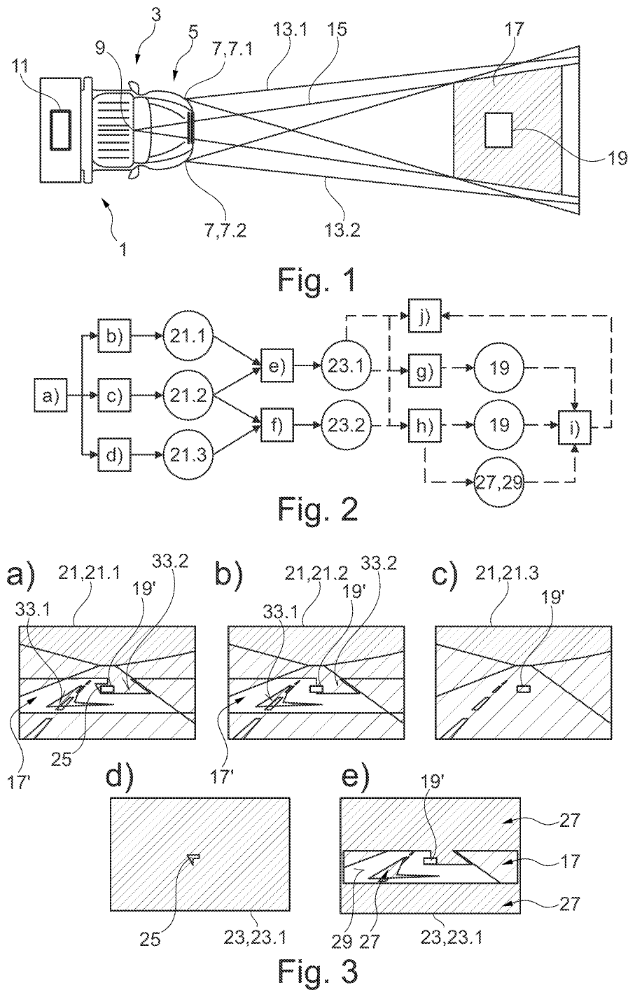

FIG. 1 shows a schematic depiction of an exemplary embodiment of a motor vehicle 1, in particular of an autonomous heavy goods vehicle, with an exemplary embodiment of a gated camera device 3. The gated camera device 3 has a gated camera 5 having a first lighting device 7.1, a second lighting device 7.2 and an optical sensor 9, in particular a camera, and a control device 11. The control device 11 is preferably operatively connected (in a manner not explicitly depicted) to the gated camera 5, in particular to the first lighting device 7.1, the second lighting device 7.2 and the optical sensor 9, and is equipped for their respective control.

The first lighting device 7.1 and the second lighting device 7.2 are arranged spaced apart from each other. Particularly preferably, the first lighting device 7.1 and the second lighting device 7.2 are arranged horizontally offset from each other. As an alternative or in addition, the first lighting device 7.1 and the second lighting device 7.2 are preferably arranged vertically offset from each other.

The first lighting device 7.1 and the second lighting device 7.2 each preferably have at least one surface emitter, in particular a so-called VCSE laser.

In FIG. 1, a first lighting frustum 13.1 of the first lighting device 7.1, a second lighting frustum 13.2 of the second lighting device 7.2 and an observation region 15 of the optical sensor 9 is depicted. A visible spacing region 17, which results as a sub-set of the first lighting frustum 13.1 of the first lighting device 7.1, of the second lighting frustum 13.2 of the second lighting device 7.2 and of the observation region 15 of the optical sensor 9 is additionally depicted by cross-hatching. An object 19 is arranged within the visible spacing region 17.

The control device 11 is in particular equipped to carry out an exemplary embodiment—described in more detail in FIG. 2—of a method for operating the gated camera 5 with the first lighting device 7.1, the second lighting device 7.2 and the optical sensor 9.

FIG. 2 shows a flow diagram of an exemplary embodiment of a method for operating the gated camera 5.

Identical and functionally identical elements are provided with the same reference signs in all figures, such that reference is respectively made to the preceding description.

In a first step a), a control of the first lighting device 7.1, the second lighting device 7.2 and the optical sensor 9 are temporally coordinated with each other, wherein the visible spacing region 17 is assigned to the coordinated control.

In a second step b), a first recording 21.1 is recorded with the optical sensor 9 by means of the coordinated control in the event of illumination by means of the first lighting device 7.1.

In a third step c), a second recording 21.2 is recorded with the optical sensor 9 by means of the coordinated control in the event of illumination by means of the second lighting device 7.2.

In a fourth step d), a third recording 21.3 is recorded with the optical sensor 9 without illumination by means of one of the lighting devices 7.

Preferably, in a first temporal sequence, the first recording 21.1 is recorded first, temporally after that the second recording 21.2 and temporally after that the third recording 21.3. As an alternative, in a second temporal sequence, the first recording 21.1 is preferably recorded first, temporally after that the third recording 21.3 and temporally after that the second recording 21.2. As an alternative, in a third temporal sequence, the second recording 21.2 is preferably recorded first, temporally after that the first recording 21.1 and temporally after that the third recording 21.3. As an alternative, in a fourth temporal sequence, the second recording 21.2 is preferably recorded first, temporally after that the third recording 21.3 and temporally after that the first recording 21.1. As an alternative, in a fifth temporal sequence, the third recording 21.3 is preferably recorded first, temporally after that the first recording 21.1 and temporally after that the second recording 21.2. As an alternative, in a sixth temporal sequence, the third recording 21.3 is preferably recorded first, temporally after that the second recording 21.2 and temporally after that the first recording 21.1.

In an alternative embodiment of the method, in the second step b), the second recording 21.2 is preferably recorded with the optical sensor 9 by means of the coordinated control in the event of illumination by means of the second lighting device 7.2. In addition, in the third step c), the first recording 21.1 is preferably recorded with the optical sensor 9 by means of the coordinated control in the event of illumination by means of the first lighting device 7.1.

In a fifth step e), a first difference recording 23.1 is formed as a difference between the first recording 21.1 and the second recording 21.2.

In a sixth step f), a second difference recording 23.2 is formed as a difference between the second recording 21.2 and the third recording 21.3. As an alternative, the second difference recording 23.2 is preferably formed as a difference between the first recording 21.1 and the third recording 21.3.

In an optional seventh step g), objects 19, in particular objects 19′ in the image, are preferably searched for in the first difference recording 23.1. Preferably, the object 19 is detected in the first difference recording 23.1 using a shadow 25 cast in the image.

In an optional eighth step g), objects 19, in particular objects 19′ in the image, are preferably searched for in the second difference recording 23.2. As an alternative or in addition, blind spots 27 are preferably searched for in the second difference recording 23.2, wherein reliability regions 29 of the recordings 21, 23 are defined using the found blind spots 27.

In an optional ninth step i), the objects 19 found in the first difference recording 23.1 are verified using the reliability regions 29. As an alternative or in addition, a base point 31 in the image of at least one of the found objects 19 is preferably determined.

In an optional tenth step j), a future movement trajectory is determined using the—optionally verified—first difference recording 23.1 and/or the—optionally verified—second difference recording 23.2.

FIG. 3 shows a schematic depiction of a first example of the first recording 21.1, the second recording 21.2, the third recording 21.3, the first difference recording 23.1 and the second difference recording 23.2.

FIG. 3 a) shows a schematic depiction of the first example of the first recording 21.1. The spacing region 17′ which can be seen in the image, and the object 19′ in the image arranged therein, which forms the shadow 25 cast in the image can be clearly seen. Furthermore, a first surface 33.1 and a second surface 33.2 can in particular be seen within the spacing region 17′ which can be seen in the image, which appear darker in the first recording 21.1 than the rest of the spacing region 17′ which can be seen in the image. In particular, it is possible that a road surface is covered with water in a region of the first surface 33.1 on the object and in a region of the second surface 33.2 on the object, and thus in particular the photons are reflected in the manner of a mirror away from the optical sensor 9.

FIG. 3 b) shows a schematic depiction of the first example of the second recording 21.2. Unlike the first recording from FIG. 3 a), the shadow 25 cast in the image cannot be seen in FIG. 3 b). The reason for this is the in particular horizontally spaced apart arrangement of the lighting devices 7, whereby the object forms a different cast shadow 25 depending on lighting.

FIG. 3 c) shows a schematic depiction of the first example of the third recording 21.3, wherein the object 19′ in the image can be clearly seen. In particular, the third recording 21.3 is a daylight recording or an ambient light recording.

FIG. 3 d) shows a schematic depiction of the first example of the first difference recording 23.1, as a difference between the first recording 21.1 and the second recording 21.2. The only visible element in the first difference recording 23.1 is the shadow 25 of the object 19 cast in the image. Preferably, the object 19 is detected using the shadow 25 cast in the image in the first difference recording 23.1.

FIG. 3 e) shows a schematic depiction of the first example of the second difference recording 23.2, as a difference between the second recording 21.2 and the third recording 21.3. In the second difference recording 23.2, the visible spacing region 17 and the object 19′ in the image can be seen. In particular the regions outside of the visible spacing region 17, the first surface 33.1 and the second surface 33.2 are depicted as blind spots 27. All other regions of the second difference recording 33.2 that are not blind spots 27 are in particular reliability regions 29.

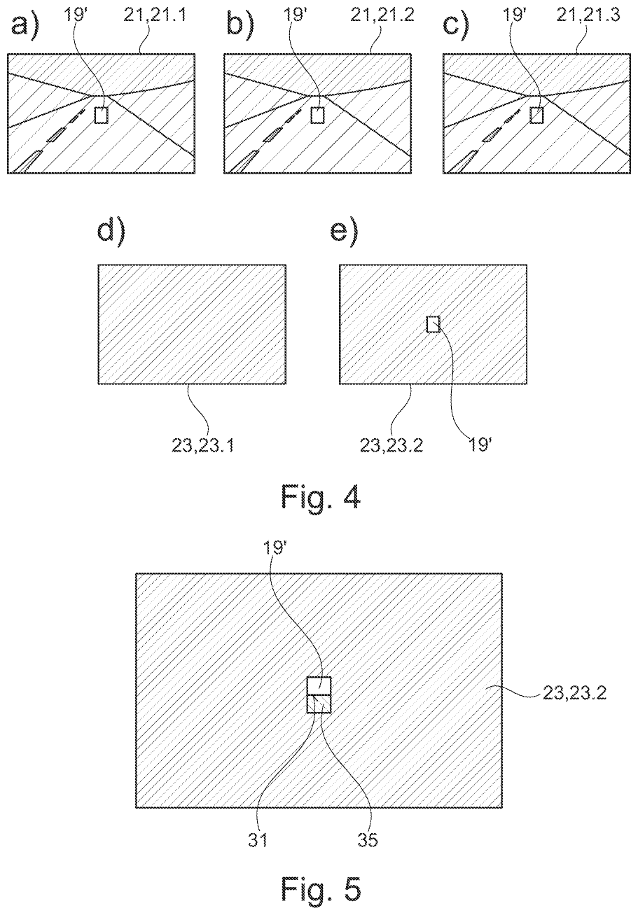

FIG. 4 shows a schematic depiction of a second example of the first recording 21.1, the second recording 21.2, the third recording 21.3, the first difference recording 23.1 and the second difference recording 23.2.

The first recording 21.1 in FIG. 4 a) and the second recording 21.2 in FIG. 4 b) are almost identical, in particular identical. The visible spacing region 17 furthermore cannot be seen. This is the case if the scene to be observed either reflects photons away from the optical sensor 9 almost exclusively in the manner of a mirror, in particular due to a very low albedo, for example if the road is wet, and/or the environment absorbs photons, and thus almost no photons are reflected.

Only the object 19 reflects in particular diffusely, and can thus be clearly seen. The remaining regions of the recording correspond to a recording without illumination by means of at least one of the lighting devices 7.

FIG. 4 c) shows, analogously to FIG. 3 c), the third recording 21.3, which is in particular a daylight recording or an ambient light recording. In the third recording 21.3 too, the object 19′ in the image can be seen, wherein the object 19′ appears less bright in comparison with the first recording 21.1 and the second recording 21.2.

FIG. 4 d) shows, analogously to FIG. 3 d), the first difference recording 23.1. Because the first recording 21.1 and the second recording 21.2 are almost identical, the first difference recording 23.1 is homogeneous in colour, and no structure, in particular no object 19, can be detected.

FIG. 4 e) shows, analogously to FIG. 3 e), the second difference recording 23.2. Here, in particular, only the object 19′ in the image can be seen. Preferably, it is thus possible to detect the object 19 by means of the second difference recording 23.2.

FIG. 5 shows a schematic depiction of the second example of the second difference recording 23.2.

It is assumed in this case that the environment of the object 19 reflects photons in the manner of a mirror, and thus a mirroring 35 of the object 19 can be seen in the second difference recording 23.2 in addition to the object 19′ in the image. The object 19′ in the image and the mirroring 35 are identified using a horizontal symmetry, such that a base point of the object 19 can be determined.

1-10. (canceled)

11. A method for operating a gated camera (5) having a first lighting device (7.1), a second lighting device (7.2) spaced apart from the first lighting device (7.1), and an optical sensor (9), comprising the steps of:
a control of the first lighting device (7.1), of the second lighting device (7.2), and of the optical sensor (9) are temporally coordinated with each other;
assigning a visible spacing region (17) to the coordinated control;
recording a first recording (21.1) with the optical sensor (9) by the coordinated control in an event of illumination by the first lighting device (7.1);
recording a second recording (21.2) with the optical sensor (9) by the coordinated control in an event of illumination by the second lighting device (7.2);
recording a third recording (21.3) with the optical sensor (9) without illumination by one of the first lighting device (7.1) and the second lighting device (7.2);
forming a first difference recording (23.1) as a difference between the first recording (21.1) and the second recording (21.2); and
forming a second difference recording (23.2) as a difference between the first recording (21.1) and the third recording (21.3) or as a difference between the second recording (21.2) and the third recording (21.3).

12. The method according to claim 11, further comprising the step of applying a method for image registration to the first recording (21.1), the second recording (21.2), and the third recording (21.3) before forming the first difference recording (23.1) and the second difference recording (23.2).

13. The method according to claim 11, wherein objects (19) are searched for in the first difference recording (23.1) and/or the second difference recording (23.2).

14. The method according to claim 11, wherein blind spots (27) are searched for in the second difference recording (23.2), wherein a pixel of a recording (21, 23) is defined as a blind spot (27) when a luminance of the pixel is less than a pre-determined threshold luminance, and wherein reliability regions (29) of the recordings (21, 23) are defined using found blind spots (27).

15. The method according to claim 14, wherein objects (19) are searched for in the first difference recording (23.1) and wherein objects (19) found in the first difference recording (23.1) are verified using the reliability regions (29).

16. The method according to claim 11, further comprising the step of determining a future movement trajectory of a motor vehicle (1) having the gated camera (5) on a basis of the first difference recording (23.1) and/or the second difference recording (23.2).

17. The method according to claim 11, further comprising the step of performing a base point determination on an object (19) found in the second difference recording (23.2).

18. A control device (11) configured to perform the method according to claim 11.

19. A gated camera device (3), comprising:
a first lighting device (7.1);
a second lighting device (7.2);
an optical sensor (9); and
a control device (11) configured to perform the method according to claim 11, wherein the first lighting device (7.1) and the second lighting device (7.2) are disposed horizontally offset from each other.

20. A motor vehicle (1), comprising:
a gated camera device (3), wherein the gated camera device (3) includes:
a first lighting device (7.1);
a second lighting device (7.2);
an optical sensor (9); and
a control device (11) configured to perform the method according to claim 11, wherein the first lighting device (7.1) and the second lighting device (7.2) are disposed horizontally offset from each other.
